(19) United States
(12) Patent Application Publication
(10) Pub. No.: US 2007/0293175 A1
(43) Pub. Date: Dec. 20, 2007

(54) SEMICONDUCTOR INTEGRATED CIRCUIT

(75) Inventors: Tetsuro SUGIOKA, KYOTO (JP); Sueko WATANABE, OSAKA (JP); Kenji MURAKAMI, KYOTO (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/755,602

(22) Filed: May 30, 2007

(30) Foreign Application Priority Data
Jun. 1, 2006 (JP) 2006-153502

(51) Int. Cl. H04B 1/10

(52) U.S. Cl. 455/224

(57) ABSTRACT

The voltage on the most sensitive noise sensing line that is thin and long inside in terms of layout and is near the power supply line or the ground line is captured by use of the system clock. A layout fixing logic constituted by a flip-flop is provided, and only when the voltage on the noise sensing line is changed due to noise or the like, first sensing data is outputted at low level from the layout fixing logic. Noise immunity characteristics can be improved by changing the circuit operation of the memory by the first sensing data.

### BACKGROUND OF THE INVENTION

1. Field of the Invention

The present invention relates to a semiconductor integrated circuit capable of sensing noise applied to the internal circuit and improving noise immunity characteristics in the internal circuit.

2. Related Art

In conventional semiconductor integrated circuits, when an unused addressing domain is specified, the ROM and the RAM are automatically disabled and a predetermined instruction code is generated to thereby prevent the occurrence of abnormality due to malfunction of the microcomputer (see, for example, Japanese Unexamined Patent Application Publication No. S55-83945).

In some semiconductor integrated circuits, to cope with malfunction of semiconductor integrated circuits due to noise, initialization by resetting is performed after malfunction occurs.

However, in conventional semiconductor integrated circuits, since no noise sensing circuit is present, it is impossible to sense noise and change the operation method to thereby improve noise immunity characteristics.

Moreover, since a plurality of sense amplifiers are simultaneously operated when memory data is read and this causes a large peak current, the power supply fluctuates. When the power supply fluctuation and external noise application occur simultaneously, the noise immunity characteristics of the semiconductor integrated circuit is deteriorated.

Moreover, since the semiconductor integrated circuit is initialized by resetting after malfunction occurs due to noise, normal operation cannot be continued.

Moreover, with the recent increase in the speed of semiconductor integrated circuits, a synchronous circuit has been becoming essential, and the improvement in the noise immunity characteristics of the clock line is a problem to be solved.

### SUMMARY OF THE INVENTION

An object of the present invention is to provide a semiconductor integrated circuit capable of detecting noise.

Another object of the present invention is to provide a semiconductor integrated circuit capable of improving noise immunity characteristics.

Yet another object of the present invention is to provide a semiconductor integrated circuit capable of continuing normal operation even when noise occurs.

To solve the above-mentioned objects, a semiconductor integrated circuit according to a first aspect of the invention includes: a noise sensing line; and a noise detection circuit that samples a voltage occurring on the noise sensing line, by use of a noise sensing clock.

To improve noise detectivity, preferably, the noise sensing clock is faster than the system clock. By sampling the voltage by use of the clock faster than the system clock, noises longer than the period of the system clock can be sensed with reliability, and noise detectivity is higher for noises shorter than the period of the system clock.

According to this structure, a signal sensitive to noise can be sensed in the semiconductor integrated circuit.

Preferably, the noise sensing line constitutes a twisted structure with respect to a power supply line or a ground line in terms of layout, or is disposed near an internal circuit sensitive to noise. As the internal circuit sensitive to noise, for example, a logic circuit or a dynamic circuit whose threshold value is low for power supply fluctuation is considered.

In the semiconductor integrated circuit according to the first aspect of the invention, preferably, a memory is incorporated that is provided with: a first sense amplifier of n bits (n is an integer not less than 2) that operates in a first condition where an output of the noise detection circuit does not represent detection of noise; and a second sense amplifier of one bit that operates in a second condition where the output of the noise detection circuit represents detection of noise.

According to this structure, power supply fluctuation can be reduced to thereby improve noise immunity characteristics.

A semiconductor integrated circuit according to a second aspect of the invention includes: a plurality of noise sensing lines sensitive to noise; a plurality of noise detection circuits that sample voltages occurring on the noise sensing lines by use of a delay clock of a system clock, respectively; and a logic circuit that performs logic synthesis processing on noise sensing data outputted from each of the noise detection circuits.

According to this structure, since noises physically in various positions in the semiconductor integrated circuit can be detected and noises caused a certain period of time behind the system clock can also be detected, noise detectivity can be improved.

In the semiconductor integrated circuit according to the second aspect of the invention, preferably, a memory is incorporated that is provided with: a first sense amplifier of n bits (n is an integer not less than 2) that operates in a first condition where an output of the logic circuit does not represent detection of noise; and a second sense amplifier of one bit that operates in a second condition where the output of the logic circuit represents detection of noise.

According to this structure, power supply fluctuation can be reduced to thereby improve noise immunity characteristics.

In the case of a structure having the first and second sense amplifiers like the above-described structure, preferably, the following are included: a serial transmission circuit connected to the second sense amplifier; a serial/parallel conversion circuit that is connected to the serial transmission circuit and outputs n-bit data; a parallel transmission circuit that is connected to the first sense amplifier and outputs n-bit data; and a wired OR portion that combines the n-bit data outputted from the serial/parallel conversion circuit and the n-bit data outputted from the parallel transmission circuit.

According to this structure, by switching the method of data transmission from the memory from the parallel method to the serial method by noise sensing in the microcomputer, the power supply fluctuation in the transmission can be reduced to thereby improve noise immunity characteristics.

Moreover, in the above-described structure, preferably, a PLL circuit that multiplies the system clock n-fold is included, and an n-fold clock outputted from the PLL circuit is supplied as an operating clock of the second sense amplifier, a serial transmission circuit, and a serial/parallel conversion circuit.

According to this structure, by switching the method of data transmission from the memory from the parallel method to the serial method by noise sensing in the microcomputer, the power supply fluctuation in the transmission can be reduced to thereby improve noise immunity characteristics, and by adjusting, by the PLL circuit, the transmission clock when the transmission method is switched to the serial method, the amount of data transmitted in a certain period of time when the parallel transmission method is used and that when the serial transmission method is used can be made the same.

In the structures of the first and second aspects of the invention, preferably, the following are included: a CPU; a memory in which data including a bit representing whether the data is an instruction or not is present; an instruction notification circuit that provides notification as to whether data that is read next is an instruction or not from a current operation of the CPU; an instruction determination circuit that determines whether or not the bit representing whether the data is an instruction or not which bit is included in the data outputted from the memory and the instruction notification signal outputted from the instruction notification circuit coincide with each other, by comparing the bit and the instruction notification signal with each other; and stop signal generation means for generating a CPU stop signal when the instruction determination circuit determines that the bit and the instruction notification signal do not coincide with each other.

According to this structure, by providing the memory in which the data including the bit representing whether the data is an instruction or not is present, the instruction notification circuit, and the instruction determination circuit, erroneous reading of memory data due to noise can be sensed.

In the structures of the first and second aspects of the invention, preferably, a CPU, a memory, and an address correction circuit are included, and when noise is sensed by the noise detection circuit, the CPU is temporarily stopped, and data of an address corrected by the address correction circuit is obtained from the memory, and the operation of the CPU is restored.

According to this structure, by reissuing the address by the CPU, temporarily stopping the instruction execution by the CPU, and rereading of the memory data by noise sensing in the microcomputer, the possibility of malfunction due to erroneous transmission of the memory data can be avoided. Consequently, normal operation can be continued even if noise is caused.

As described above, according to the present invention, by providing the noise detection circuit, the noise immunity characteristics of the semiconductor integrated circuit can be improved.

### BRIEF DESCRIPTION OF THE DRAWINGS

FIG. 1A is a block diagram showing the structure of a noise sensing circuit of a first embodiment of the present invention;

FIG. 1B is a block diagram showing the structure of another noise sensing circuit of the first embodiment of the present invention;

FIG. 2 is a block diagram showing the structure of a semiconductor integrated circuit of the present invention realizing noise sensing and improvement in noise immunity characteristics;

FIG. 3 is a timing chart in a fourth embodiment of the present invention;

FIG. 4 is a timing chart in a fifth embodiment of the present invention;

FIG. 5 is a timing chart in normal operation in the fourth embodiment of the present invention;

FIG. 6 is a timing chart when noise is applied in the fifth embodiment of the present invention; and

FIG. 7 is a timing chart in a seventh embodiment of the present invention.

### DESCRIPTION OF THE PREFERRED EMBODIMENTS

Hereinafter, embodiments of the present invention will be described with reference to the drawings.

### First Embodiment

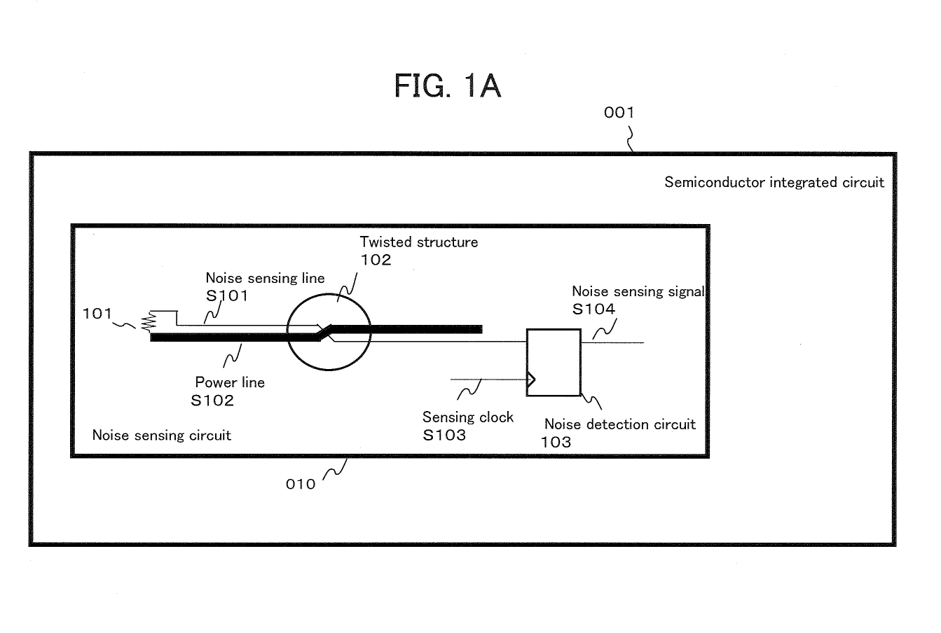

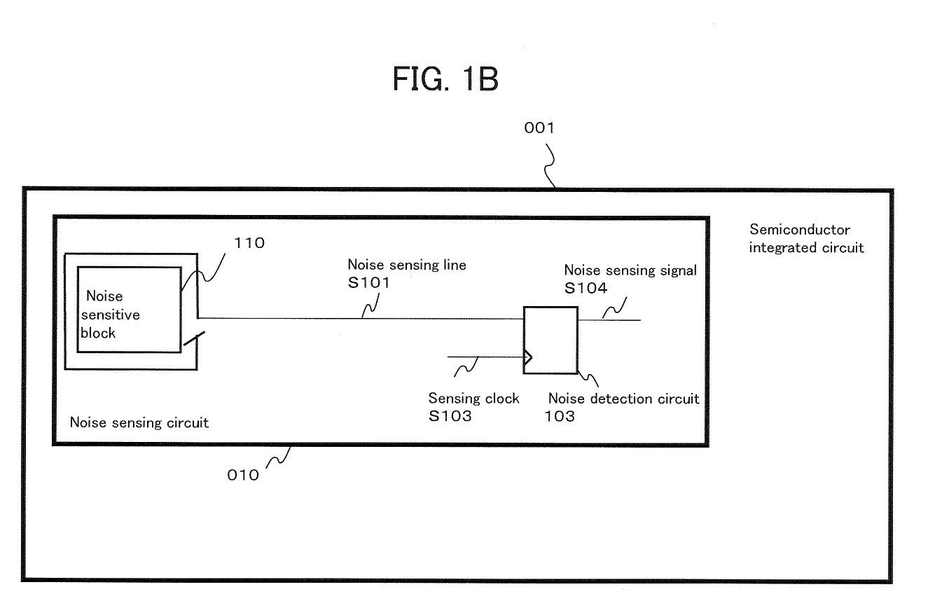

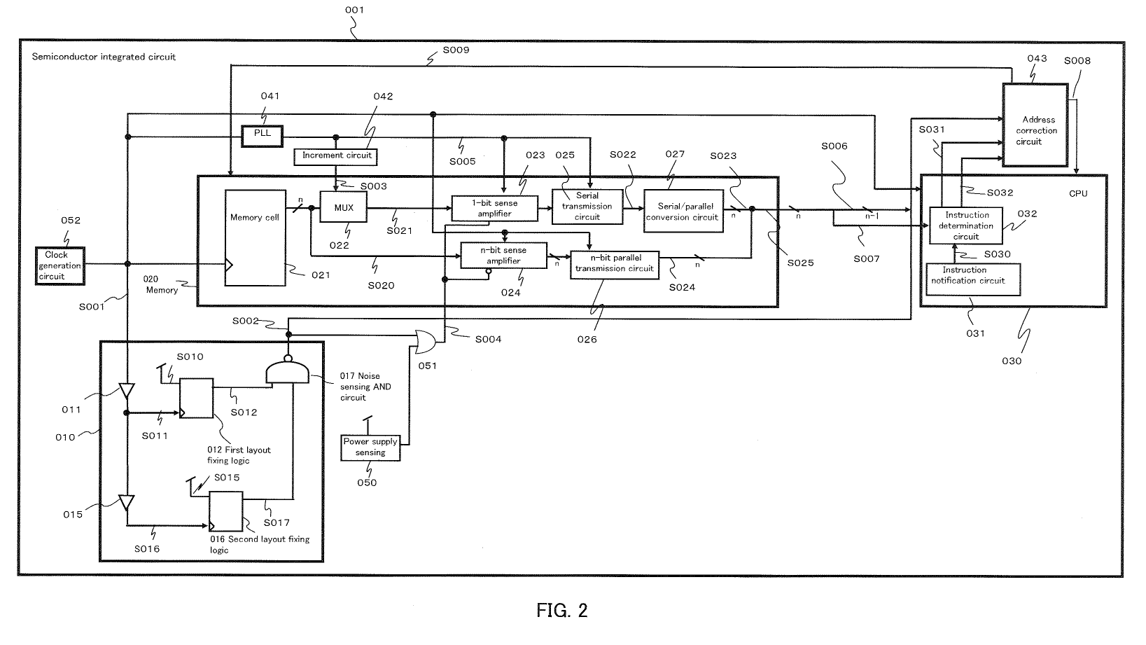

FIGS. 1A and 1B show a semiconductor integrated circuit 001 of a first embodiment of the present invention that performs noise sensing. In FIGS. 1A and 1B, although the structures of the parts other than a noise sensing circuit 010 are not shown, they are similar to those of the parts other than the semiconductor integrated circuit 001 in FIG. 2 described later.

In FIG. 1A, reference designation S101 represents a noise sensing line, reference designation S102 represents a power supply line, and reference designation 101 represents a resistor having a high resistance. The noise sensing line S101 is directly coupled by the power supply line S102 by use of the resistor 101 having a high resistance. Reference designation S103 represents a noise sensing clock that is faster than the system clock. Reference designation 103 represents a noise detection circuit that samples the voltage occurring on the noise sensing line S101, by use of the noise sensing clock S103 and outputs the sampled voltage as a noise sensing signal S104.

The noise detection circuit 103 is constituted by a flip-flop with the noise sensing line S101 as the data input, the noise sensing clock S103 as the clock input, and the noise sensing signal S104 as the data output. The noise sensing line S101 and the power supply line S102 constitute a twisted structure 102.

The reason for using the noise sensing clock S103 faster than the system clock will be mentioned. In semiconductor integrated circuits, the operation is generally determined in synchronism with the system clock.

For this reason, the possibility of malfunction is extremely high when noise occurs on the signal line at the timing of the edge of the system clock. Therefore, by sampling the voltage by use of the noise sensing clock S103 faster than the system clock, noises longer than the period of the system clock can be sensed with reliability, and noise detectivity is higher for noises shorter than the period of the system clock. Here, it is in order to improve detectivity that the clock faster than the system clock is used for sampling, and detectivity increases as the frequency increases. The effect of noise detection is obtained even when the noise sensing clock is not faster than the system clock.

Next, the reason that noise can be sensed only by sampling the voltage on the noise sensing line will be mentioned. Sampling means not reading by an analog circuit such as an A/D converter but reading by a flip-flop with the noise sensing clock as the clock input and the voltage on the noise sensing line as the data input. Therefore, it can be determined that noise occurs when the voltage on the noise sensing line is not more than the threshold value of the transistor that receives data in the flip-flop without the need to convert the voltage into a numerical value and compare the numerical value with the threshold value.

Next, the kinds of noise to be sensed will be described. A first kind is a noise directly applied from the outside to the power supply terminal, a communication terminal for exchanging signals, an oscillation terminal for inputting clocks, and a mode setting terminal for setting the mode of the semiconductor integrated circuit. A second kind is a noise caused by electromagnetic waves which noise is not directly applied but fluctuates the internal potential. A third kind is a noise produced from a circuit that requires a large peak current which circuit is mounted on the semiconductor integrated circuit.

To increase the detectivity of noise that occurs unexpectedly, the frequency of the noise sensing clock is increased as mentioned above, or a plurality of noise sensing clocks are formed by delaying the system clock and noise sensing is performed by use of the noise sensing clocks, to thereby improve the noise detectivity. The latter structure using a plurality of noise sensing clocks will be described below.

In FIG. 1B, reference designation 110 represents a noise sensitive block that is sensitive to noise. The noise sensitive block 110 is a logic circuit or a dynamic circuit whose threshold value is low for power supply fluctuation. Reference designation S101 represents a noise sensing line. Reference designation S103 represents a noise sensing clock that is faster than the system clock. Reference designation 103 represents a noise detection circuit that samples the voltage occurring on the noise sensing line S101, by use of the noise sensing clock S103 and outputs the sampled voltage as a noise sensing signal S104. The reason that noise can be detected only by performing sampling is as described previously.

The noise sensing line S101 is a signal wiring that is long and thin inside the semiconductor integrated circuit 001 in terms of layout and is the most sensitive when it is near the power supply line or the ground (GND) line in the formation of the semiconductor integrated circuit 001.

As the noise sensing line S101, for example, a signal line constituting the twisted structure 102 as shown in FIG. 1A in terms of layout with respect to the power supply line or the GND line is formed, and this signal line is used. Alternatively, a sensitive signal wiring is intentionally formed near the noise sensitive block 110 like the noise sensitive block 110 of FIG. 1B in the semiconductor integrated circuit 001 and this is used as the noise sensing line S101. Here, as the noise sensitive block, for example, a logic circuit or a dynamic circuit whose threshold value is low for power supply fluctuation is considered. In such a circuit, the internal signal voltage is largely changed by noise, and the change is detected by the noise sensing line.

In the noise detection circuit 103, the voltage occurring on the noise sensing line S101 is sampled by use of the noise sensing clock S103 faster than the system clock both when the voltage is changed by noise or the like and when it is not changed, the noise sensing signal S104 outputted from the noise detection circuit 103 is changed only when the voltage occurring on the noise sensing line S101 is changed by noise or the like.

By this structure, when ingress of a signal of a frequency not for performing a given operation or power supply line fluctuation occurs due to a noise or the like in the semiconductor integrated circuit 001, this can be detected as noise.

### Second Embodiment

FIG. 2 is a block diagram showing the structure of a semiconductor integrated circuit realizing noise sensing and improvement in noise immunity characteristics according to a second embodiment of the present invention.

The noise sensing circuit 010 in FIG. 2 shows the second embodiment of the present invention. In the noise sensing circuit 010, reference designation S001 represents the system clock, reference designation S011 represents a first delay clock which is the system clock S001 that is delayed, and reference designation S016 is a second delay clock which is the system clock S001 that is further delayed. Reference designation S010 represents a first noise sensing line, and reference designation S015 represents a second noise sensing line. Reference designation S002 represents a noise sensing signal, reference designation 011 represents a first delay element, and reference designation 015 represents a second delay element. Reference designation 012 represents a first layout fixing logic. The first layout fixing logic 012 is constituted by a flip-flop with the first delay clock S011 as the clock input. Reference designation 016 represents a second layout fixing logic. The second layout fixing logic 016 is constituted by a flip-flop with the second delay clock S016 as the clock input. Reference designation S012 represents first sensing data which is the output of the first layout fixing logic 012, reference designation S017 represents second sensing data which is the output of the second layout fixing logic 016, and reference designation 017 represents a noise sensing AND circuit.

The system clock S001 determines the operation clock frequency of the CPU, and is necessary for internal operations of the CPU and peripheral functions. The first delay element 011 and the second delay element 015 may have any structure as long as the sum of the delay times of the delay elements (delay time Δt, number n) is not more than one period of the system clock S001 (Δt*n≦one period of the system clock S001), one or more delay elements are disposed as a structure that can sample the noise caused within one period of the system clock S001, and the system clock S001 is delayed and outputted. Since it is in order to sample noise a plurality of number of times in one period of the system clock S001 that the system clock S001 is delayed before outputted as described above, noise may be sampled by use of not a delay clock but a clock faster than the system clock S001.

Since noise can be sampled a plurality of number of times in one period of the system clock by using a delay clock and similar effects as those obtained when noise is sampled by a high-speed clock are obtained, it is unnecessary that the noise sensing clock be fast.

It is in order to solve the following problem that noises on a plurality of noise sensing lines are sensed by sampling them by use of delay clocks with different delay times with respect to the system clock and the sensed noises are combined. This is because when a noise occurs a certain period of time behind the noise sensing clock, the noise cannot be sensed by a noise sensing circuit that samples noise by use of a noise sensing clock. To sense such a noise, a noise detection circuit is provided that samples noise by a second noise sensing clock delayed the certain period of time from the noise sensing clock. This enables the sensing of noise delayed a certain period of time from the noise sensing clock.

It is difficult to predict where in the semiconductor integrated circuit noise is caused or if noise is applied externally. Therefore, noise detectivity can be increased by physically disposing a plurality of noise sensing circuits in various positions in the semiconductor integrated circuit.

For example, when a noise is applied to the right end of the semiconductor integrated circuit, if a noise sensing circuit is disposed only on the left end, the noise is highly unlikely to be sensed. However, by disposing a noise sensing circuit also on the right end, the probability that the noise is sensed becomes higher.

In the noise sensing circuit 010 that senses signals sensitive to noise, a signal wiring that is long and thin inside in terms of layout and is the most sensitive when it is near the power supply line or the GND line in the formation of the semiconductor integrated circuit 001 is used as the noise sensing line. Alternatively, sensitive signal wirings are intentionally formed on a line near a logic circuit with a large power supply fluctuation and on a line near a dynamic circuit in the semiconductor integrated circuit 001, and these are used as the first noise sensing line S010 and the second noise sensing line S015. A concrete example is as shown in FIG. 1A. Since the noise sensing line S101 and the power supply line S102 are parallel to each other, an additional capacitance is generated. Since the noise sensing line S101 is supplied with potential through the resistor, the voltage holding capability is low. For this reason, this is called a sensitive signal. When a power supply fluctuation occurs on the power supply line S102 under such a condition, the potential of the noise sensing line S101 also fluctuates. When the fluctuation exceeds the threshold value of the noise detection circuit 103, it is determined that noise occurs.

The voltages occurring on the first noise sensing line S010 and the second noise sensing line S015 are captured by the first layout fixing logic 012 and the second layout fixing logic 016 in a period of time shorter than one period of the system clock S001 both when the voltages are changed by noise or the like and when they are not changed, and the noise sensing signal S002 is outputted from the noise sensing AND circuit 017 only when data opposite in polarity to the first noise sensing line S010 and the second noise sensing line S015, that is, the first noise sensing line S010 and the second noise sensing line S015 exceed the threshold values of the first layout fixing logic 012 and the second layout fixing logic 016 because of noise or the like.

In this structure, the noise sensing period is as follows: In the case of only the first layout fixing logic 012, sampling is performed once every period of the system clock. In the present invention, by providing a plurality of (a number, n, of) layout setting logics and obtaining the inverted AND of the outputs thereof, sampling can be performed a plurality of number of times (a number, n, of times) in one period of the system clock.

The significance of obtaining the inverted AND of the outputs of the first layout fixing logic 012 and the second layout fixing logic 016 will be mentioned. In the embodiment, the outputs of the first layout fixing logic 012 and the second layout fixing logic 016 are high (hereinafter, referred to as “H”) when no noise is sensed (∵because of the output of the flip-flop whose clock is the voltage level of the first noise sensing line S010 and the second noise sensing line S015 which is “H”).

When noise is received, the output of the first noise sensing line S010 or the second noise sensing line S015 becomes low (hereinafter, referred to as “L”), and when the first delay clock S011 or the second delay clock S016 rises at that time, the first sensing data S012 or the second sensing data S017 changes to “L”. When at least one of the pieces of sensing data becomes “L”, since this indicates that noise is detected, the inverted AND of a plurality of (two in the case of the figure) pieces of sensing data is obtained, and this is used as the noise sensing signal S002.

The logic used at this time may be any logic as long as noise can be detected only when the potentials of the first noise sensing line S010 and the second noise sensing line S015 are changed by noise or the like.

While in the semiconductor integrated circuit 001, the first noise sensing line S010 and the second noise sensing line S015 are fixed at the power supply potential and the logic for outputting the noise sensing signal S002 is created by the change of the potential, the first noise sensing line S010 and the second noise sensing line S015 may be fixed at the GND potential. In that case, the logic for outputting the noise sensing signal S002 is also different from that mentioned above.

By this structure, even if a signal of a frequency not for performing a given operation enters the semiconductor integrated circuit 001 due to noise or the like while the CPU is operating, the signal can be detected as noise, and whether the bus method or the serial method is used to transmit memory data from the ROM to the CPU can be selected by the noise sensing signal. The circuit for selecting the method of transmission of the memory data from the ROM to the CPU will be described later.

### Third Embodiment

FIG. 2 shows the internal block of a memory 020 for realizing the improvement in memory noise immunity characteristics in a semiconductor integrated circuit of a third embodiment of the present invention.

A memory cell 021 outputs data in a given number, n, of bits. Reference designation S020 represents a number, n, of buses (n-bit bus) outputted from the memory cell 021. Reference designation 042 represents an increment circuit that is fed with an n-fold clock S005 and increments the output value at intervals of the period of the n-fold clock S005. Reference designation 022 represents a selection circuit that selects one signal from the buses S020 based on an increment signal S003 outputted from the increment circuit 042. Reference designation S021 represents a selection circuit output signal outputted from the selection circuit 022. Reference designation 023 represents a one-bit sense amplifier that determines the signal S021. The one-bit sense amplifier 023 operates when a data transmission selection signal S004 is “H”. Reference designation 024 represents an n-bit sense amplifier that determines the signals on the buses S020. The n-bit sense amplifier 024 operates when the data transmission selection signal S004 is “L”.

The data transmission selection signal S004 is generated by obtaining the OR of the noise sensing signal S002 of the noise sensing circuit 010 and the output signal of a power supply sensing circuit 050 by an OR circuit 051. When a drop in power supply voltage is detected by the power supply sensing circuit 050, the one-bit sense amplifier 023 selectively operates, and the n-bit sense amplifier 024 stops operating. When the power supply voltage is normal, the n-bit sense amplifier 024 operates, and the one-bit sense amplifier 023 stops operating.

Because of this structure, the number of sense amplifiers can be selected, and the peak current value consumed by the sense amplifier can be adjusted. In addition, by this, by selecting the one-bit sense amplifier when the power supply voltage drops, power supply fluctuation can be reduced to thereby improve noise immunity characteristics.

### Fourth Embodiment

FIG. 2 shows an internal block diagram of a memory 020 that switches the method of data transmission from the memory from the parallel method to the serial method, in a semiconductor integrated circuit (microcomputer) of a fourth embodiment of the present invention, by noise sensing in the microcomputer.

Reference designation S004 represents a data transmission selection signal generated by noise sensing in the microcomputer. Reference designation 023 represents a one-bit sense amplifier. The one-bit sense amplifier 023 operates when the data transmission selection signal S004 is “H”. Reference designation 025 represents a serial transmission circuit that serially transmits, bit by bit, the data outputted from the one-bit sense amplifier 023. Reference designation S022 represents serially transmitted data of one-bit width transmitted by the serial transmission circuit 025. Reference designation 027 represents a serial/parallel conversion circuit that converts the data of one-bit width of the serially transmitted data S022 into data of n-bit bus width. Reference designation S023 represents converted parallelly transmitted data that is converted into data of n-bit width by the serial/parallel conversion circuit 027.

Reference designation 024 represents an n-bit sense amplifier. The n-bit sense amplifier 024 operates when the data transmission selection signal S004 is “L”. Reference designation 026 represents an n-bit parallel transmission circuit that performs n-bit parallel transmission of the n-bit data outputted from the n-bit sense amplifier 024. Reference designation S024 represents parallelly transmitted data of n-bit width transmitted by the n-bit parallel transmission circuit 026. Reference designation S025 represents transmitted memory data which is the wired OR of the converted parallelly transmitted data S023 transmitted by the serial method and the parallelly transmitted data S024 transmitted by the parallel method.

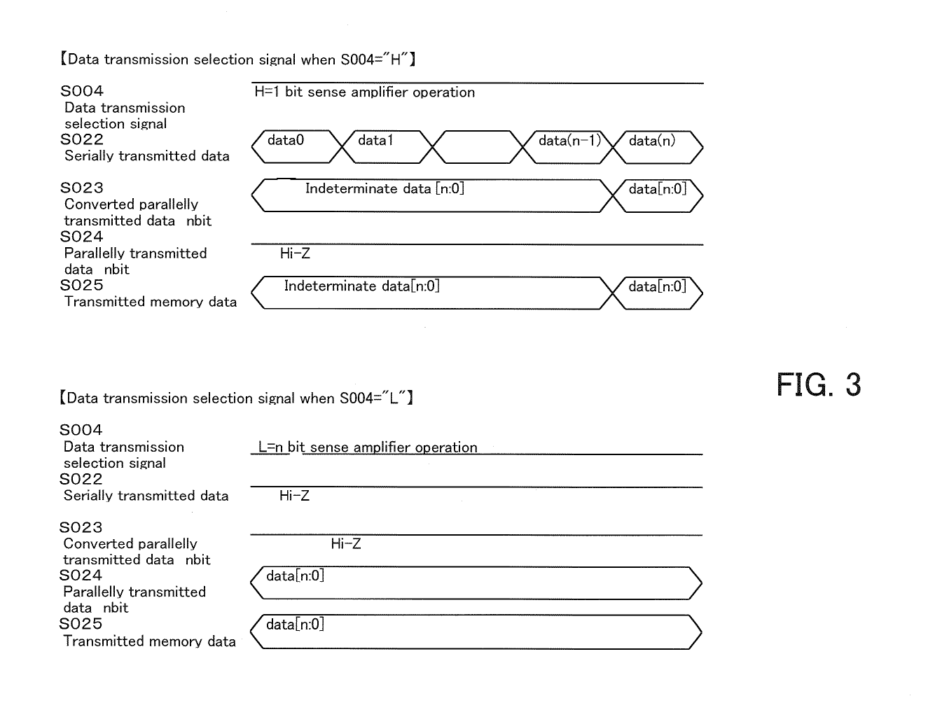

The operations performed when the data transmission selection signal S004 is “H” and “L” will be described with reference to FIG. 3. First, when the data transmission selection signal S004 is “H”, as the memory sense amplifier, the one-bit sense amplifier 023 operates. The data outputted from the one-bit sense amplifier 023 which data is transmitted serially is the serially transmitted data S022. The serially transmitted data S022 that is converted into data of n-bit width by the serial/parallel conversion circuit 027 is the converted parallelly transmitted data S023. In this case, since the n-bit sense amplifier 024 does not operate, the parallelly transmitted data S024 is of high impedance (hereinafter, referred to as Hi-Z). Since the transmitted memory data S025 which is the memory output data is the wired OR of the converted parallelly transmitted data S023 and the parallelly transmitted data S024, the converted parallelly transmitted data S023 is transmitted as the transmitted memory data S025.

When the data transmission selection signal S004 is “L”, as the memory sense amplifier, the n-bit sense amplifier 024 operates. The data outputted from the n-bit sense amplifier 024 which data is transmitted in a width of n bits is the parallelly transmitted data S024. In this case, since the one-bit sense amplifier 023 does not operate, the serially transmitted data S022 and the converted parallelly transmitted data S023 are Hi-Z. Since the transmitted memory data S025 which is the memory output data is the wired OR of the converted parallelly transmitted data S023 and the parallelly transmitted data S024, the parallelly transmitted data S024 is transmitted as the transmitted memory data S025.

By this structure, the power supply fluctuation caused when noise occurs or the power supply voltage drops can be reduced, and noise immunity can be improved.

### Fifth Embodiment

FIG. 2 shows an internal block diagram of a memory 020 and a PLL circuit 041 for switching the method of data transmission from the memory from the parallel method to the serial method and adjusting, by the PLL, the transmission clock when the transmission method is switched to the serial method, by noise sensing in the microcomputer in a fifth embodiment of the present invention.

Reference designation 041 represents the PLL circuit capable of multiplying n-fold the system clock S001 generated by a clock generation circuit 052 of the microcomputer. Reference designation S005 represents an n-fold clock which is the system clock S001 multiplied n-fold by the PLL circuit 041. Reference designation S004 represents a data transmission selection signal generated by noise sensing in the microcomputer or power supply voltage sensing by a power supply sensing circuit 050. Reference designation 023 represents a one-bit sense amplifier that operates on the n-fold clock S005. The one-bit sense amplifier 023 operates when the data transmission selection signal S004 is “H”. The serial transmission circuit 025 serially transmits, bit by bit, the data outputted from the one-bit sense amplifier 023, on the n-fold clock S005. Reference designation 022 represents serially transmitted data of one-bit width transmitted by the serial transmission circuit 025. Reference designation 027 represents a serial/parallel conversion circuit that converts the data of one-bit width of the serially transmitted data S022 into data of n-bit bus width. Reference designation S023 represents converted parallelly transmitted data that is converted into data of n-bit width by the serial/parallel conversion circuit 027.

Reference designation 024 represents an n-bit sense amplifier. The n-bit sense amplifier 024 operates when the data transmission selection signal S004 is “L”. Reference designation 026 represents an n-bit parallel transmission circuit that performs n-bit parallel transmission of the n-bit data outputted from the n-bit sense amplifier 024. Reference designation S024 represents parallelly transmitted data of n-bit width transmitted by the n-bit parallel transmission circuit 026. Reference designation S025 represents transmitted memory data which is the wired OR of the converted parallelly transmitted data S023 transmitted by the serial method and the parallelly transmitted data S024 transmitted by the parallel method.

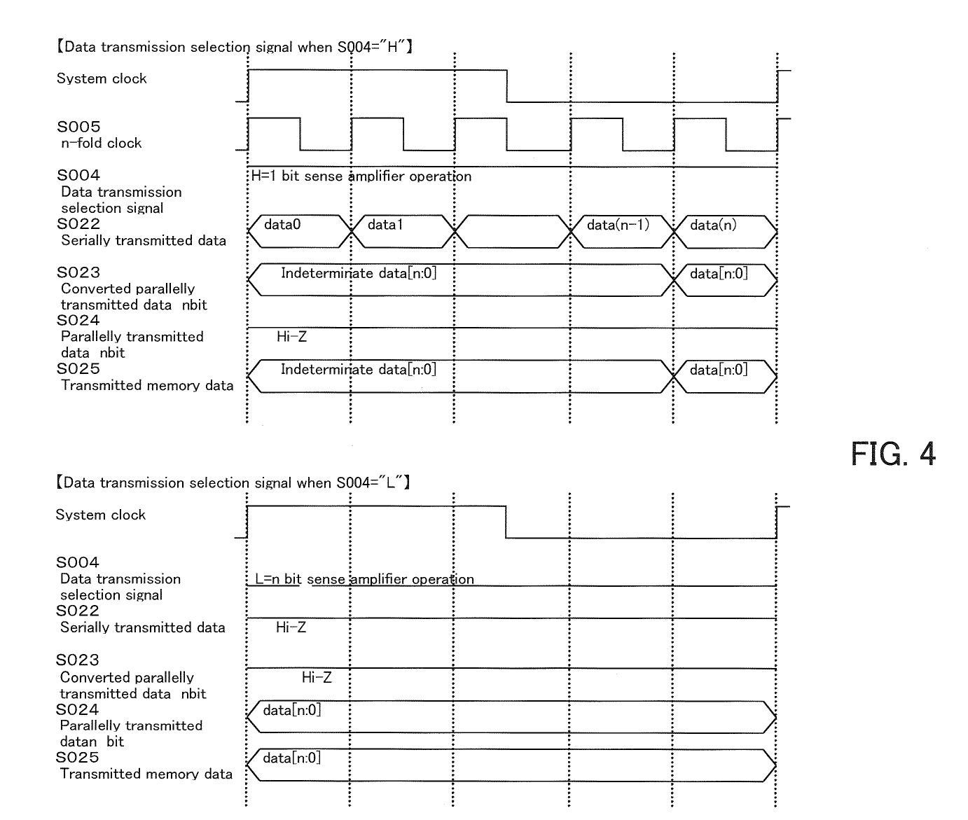

The operations performed when the data transmission selection signal S004 is “H” and “L” will be described with reference to FIG. 4. First, when the data transmission selection signal S004 is “H”, as the memory sense amplifier, the one-bit sense amplifier 023 operates on the n-fold clock S005. The data outputted from the one-bit sense amplifier 023 which data is serially transmitted on the n-fold clock S005 is the serially transmitted data S022. The serially transmitted data S022 that is converted into data of n-bit width by the serial/parallel conversion circuit 027 is the converted parallelly transmitted data S023. In this case, since the n-bit sense amplifier 024 does not operate, the parallelly transmitted data S024 is Hi-Z. Since the transmitted memory data S025 which is the memory output data is the wired OR of the converted parallelly transmitted data S023 and the parallelly transmitted data S024, the converted parallelly transmitted data S023 is transmitted as the transmitted memory data S025.

When the data transmission selection signal S004 is “L”, as the memory sense amplifier, the n-bit sense amplifier 024 operates. The data outputted from the n-bit sense amplifier 024 which data is transmitted in a width of n bits is the parallelly transmitted data S024. In this case, since the one-bit sense amplifier 023 does not operate, the serially transmitted data S022 and the converted parallelly transmitted data S023 are Hi-Z. Since the transmitted memory data S025 which is the memory output data is the wired OR of the converted parallelly transmitted data S023 and the parallelly transmitted data S024, the parallelly transmitted data S024 is transmitted as the transmitted memory data S025.

By switching the method of data transmission from the memory from the parallel method to the serial method, the power supply fluctuation in the transmission can be reduced to thereby improve noise immunity characteristics. Moreover, by transmitting data on the n-fold clock S005 at the time of serial transmission, the transmission speed of n-bit data is equal to that of parallel transmission.

### Sixth Embodiment

FIG. 2 shows the internal block for improving memory noise immunity characteristics in a semiconductor integrated circuit of a sixth embodiment of the present invention. In FIG. 2, reference designation 020 represents a memory in which data including a bit representing whether the data is an instruction or not is present. The bit representing whether the data is an instruction or not is added at the time of conversion from a program to memory data by a compiler. Reference designation S006 represents a number, n, of data buses outputted from the memory 020. Reference designation S007 represents an instruction determination signal representing whether the data is an instruction or not. Reference designation 030 represents a CPU. Reference designation 031 represents an instruction notification circuit that provides notification as to whether the data processed by the CPU 030 is an instruction or not. Reference designation S030 represents an instruction notification signal outputted from the instruction notification circuit 031. Reference designation 032 represents an instruction determination circuit that determines whether the instruction determination signal S007 and the instruction notification signal S030 coincide with each other or not. Reference designation S031 represents a determination notification signal that provides notification of the result of the comparison between the instruction determination signal S007 and the instruction notification signal S030.

Reference designation S032 represents a basic address issued by the CPU 030. Reference designation 043 represents an address correction circuit that changes a CPU stop signal S008 by the determination notification signal S031 to stop the CPU 030.

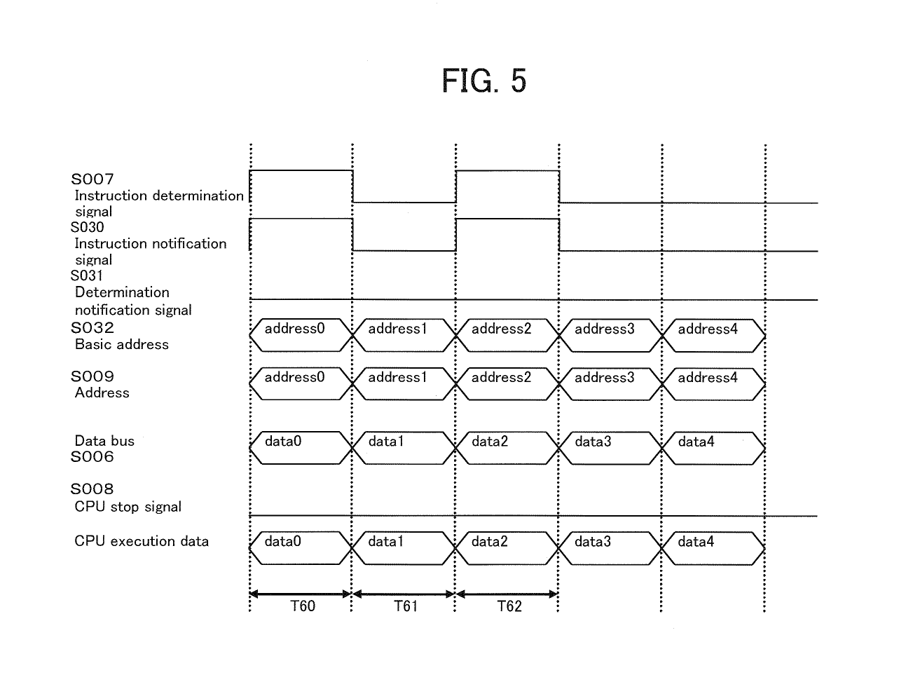

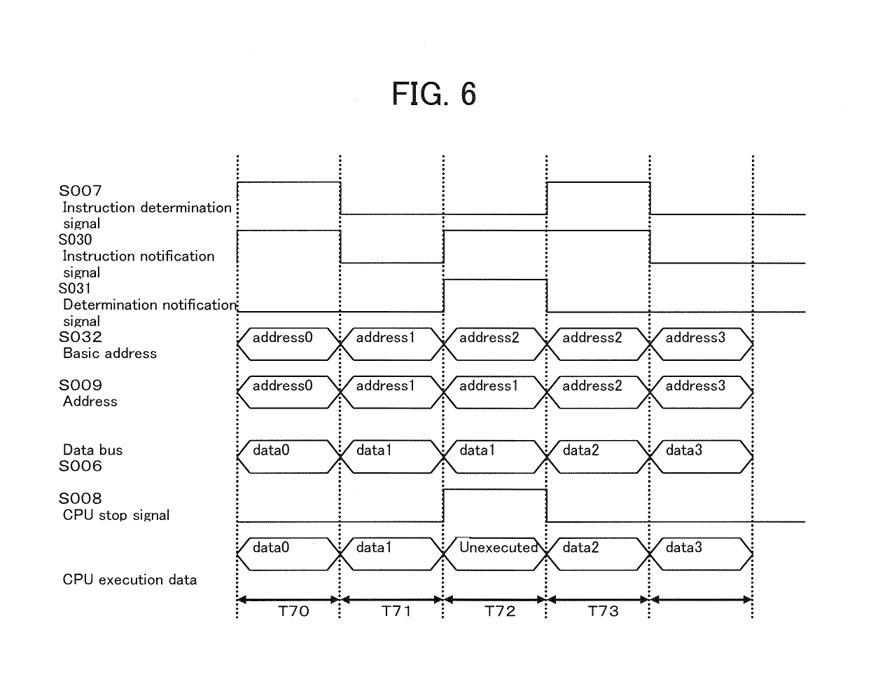

The operation will be described with reference to FIGS. 5 and 6.

FIG. 5 is the operation performed when there is no influence of noise. Reference designation T60 represents a first instruction execution period in which an instruction “data0” is executed. In the first instruction execution period T60, the instruction determination signal S007 is “H”, and the instruction notification signal S030 is “H”. Reference designation T61 represents a first data reading period in which a given numerical value “data1” processed on the instruction executed in the first instruction execution period T60 is read. Reference designation T62 represents a second instruction execution period in which an instruction “data2” is executed. The timing of start of the second instruction execution period T62 is determined by the instruction “data0” processed in the first instruction execution period T60.

FIG. 6 is the operation performed when an address S009 is changed due to noise. Reference designation T70 represents a third instruction execution period in which the instruction “data0” is executed. In the third instruction execution period T70, the instruction determination signal S007 is “H”, and the instruction notification signal S030 is “H”. Reference designation T71 represents a first data reading period in which a given numerical value “data1” processed on the instruction executed in the third instruction execution period T70 is read. The period T72, which is originally an instruction execution period for executing the instruction “data2”, is an address changed period in which the address S009 is changed due to noise. In the address changed period T72, the address S009 is changed from “address2” to “address1”. For this reason, the instruction determination signal S007 is “L”. The instruction notification signal S030 outputs “H” since the operation is determined by the third instruction execution period T70. The determination notification signal S031 outputs “H” when the instruction determination signal S007 and the instruction notification signal S030 do not coincide with each other. The address correction circuit 043 makes the CPU stop signal S008 “H” when the determination notification signal S031 is “H”. When the CPU stop signal S008 is “H”, the CPU 30 stops operating.

Reference designation T73 represents a fourth instruction execution period. In the fourth instruction execution period T73, since the CPU 30 stops operating in the address changed period T72, the basic address S032 and the instruction notification signal S030 maintain the values in the address changed period T72. The instruction determination signal outputs “H”, and an operation similar to that performed in the second instruction execution period T62 is performed.

By adopting the structure that determines whether the instruction determination signal S007 and the instruction notification signal S030 coincide with each other or not as described above, erroneous reading of memory data due to noise can be sensed.

### Seventh Embodiment

FIG. 2 shows an internal block diagram for avoiding CPU malfunction due to erroneous transmission of the memory data, by noise sensing in the microcomputer in a seventh embodiment of the present invention.

Reference designation S002 represents a noise sensing signal in the microcomputer. Reference designation S032 represents a basic address issued by the CPU 030. Reference designation 043 represents an address correction circuit that corrects the basic address S032 to an immediately previously specified address. Reference designation S008 represents a CPU stop signal to notify the CPU 030 of the performance of the address correction by the address correction circuit 043 and temporarily stops the execution of the current data and instruction having been transmitted to the CPU 030. Reference designation S009 represents an address to specify the memory.

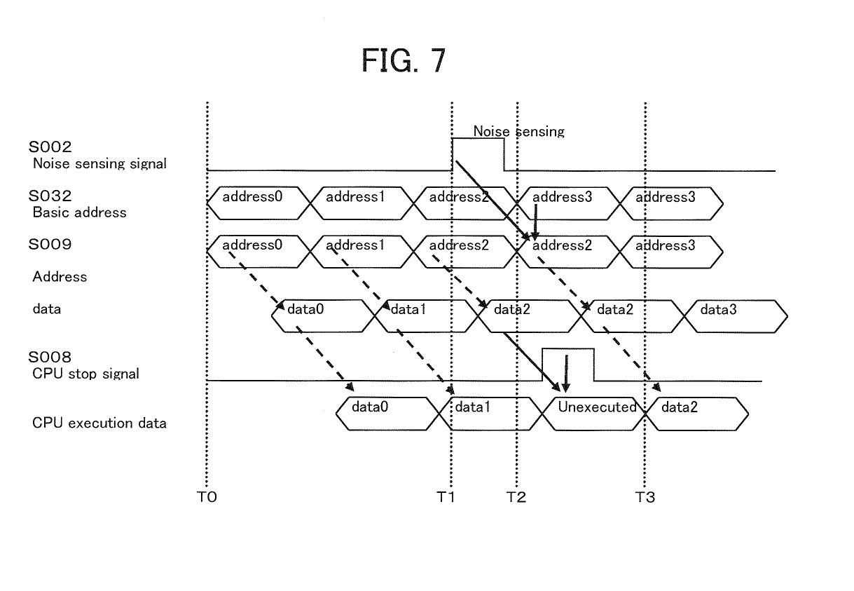

The operation will be described with reference to FIG. 7. From the address0 issue timing T0 to the noise sensing timing T1, normal operation is performed without noise sensing performed. The basic address S032 issued by the CPU 030 specifies the memory as the address S009 without correction. The CPU 030 executes the executed and transmitted instruction and data. At the timing T1, noise is sensed, and at the timing T2, an address correction occurs. Although the CPU 030 increments the address and issues address3 at the timing T2, by the noise sensing signal, the immediately previously selected address2 is specified as the address S009 by the address correction circuit 043. From the timing T2 to the corrected address data execution timing T3, data2 specified at address 2 is re-transmitted from the memory 020 to the CPU 030. The CPU 30 receives the CPU stop signal S008 at this timing, and does not execute data2 already transmitted at present. Noise sensing is discontinued, and at the timing T3, the CPU 030 completes the transmission of the transmission data data2 specified at address2 and starts to execute data 2. After the timing T3 when noise sensing is discontinued, normal operation is performed, and the basic address S032 issued by the CPU 030 specifies the memory as the address S009 without correction. The CPU 030 executes the executed and transmitted instruction and data.

According to this structure, by reissuing the address by the CPU, temporarily stopping the instruction execution by the CPU, and rereading of the memory data by noise sensing in the microcomputer, the possibility of malfunction due to erroneous transmission of the memory data can be avoided.

### INDUSTRIAL APPLICABILITY

The semiconductor integrated circuit according to the present invention includes noise sensing, a plurality of sense amplifiers and a discrete noise sensing amplifier selected by noise sensing, a parallel transmission circuit and a serial transmission circuit that transmit data transmitted from the two kinds of sense amplifiers, a determination circuit that determines whether the transmitted data is correct or not, and an address correction circuit that corrects the address based on the result of the determination, and is useful to improve the noise immunity characteristics of the semiconductor integrated circuit.

What is claimed is:

1. A semiconductor integrated circuit comprising:
a noise sensing line; and
a noise detection circuit that samples a voltage occurring on the noise sensing line, by use of a clock.

2. A semiconductor integrated circuit according to claim 1, wherein the clock is faster than a system clock.

3. A semiconductor integrated circuit according to claim 1, wherein the noise sensing line constitutes a twisted structure with respect to a power supply line or a ground line in terms of layout.

4. A semiconductor integrated circuit according to claim 1, wherein the noise sensing line is disposed near an internal circuit sensitive to noise.

5. A semiconductor integrated circuit according to claim 4, wherein the internal circuit sensitive to noise is a logic circuit whose threshold value is low for power supply fluctuation.

6. A semiconductor integrated circuit according to claim 4, wherein the internal circuit sensitive to noise is a dynamic circuit.

7. A semiconductor integrated circuit according to claim 1, incorporating a memory provided with:
a first sense amplifier of n bits (n is an integer not less than 2) that operates in a first condition where an output of the noise detection circuit does not represent detection of noise; and
a second sense amplifier of one bit that operates in a second condition where the output of the noise detection circuit represents detection of noise.

8. A semiconductor integrated circuit comprising:
a plurality of noise sensing lines sensitive to noise;
a plurality of noise detection circuits that sample voltages occurring on the noise sensing lines by use of a delay clock of a system clock, respectively; and
a logic circuit that performs logic synthesis processing on noise sensing data outputted from each of the noise detection circuits.

9. A semiconductor integrated circuit according to claim 8, incorporating a memory provided with:
a first sense amplifier of n bits (n is an integer not less than 2) that operates in a first condition where an output of the logic circuit does not represent detection of noise; and
a second sense amplifier of one bit that operates in a second condition where the output of the logic circuit represents detection of noise.

10. A semiconductor integrated circuit according to claim 9, comprising:
a serial transmission circuit connected to the second sense amplifier;
a serial/parallel conversion circuit that is connected to the serial transmission circuit and outputs n-bit data;
a parallel transmission circuit that is connected to the first sense amplifier and outputs n-bit data; and
a wired OR portion that combines the n-bit data outputted from the serial/parallel conversion circuit and the n-bit data outputted from the parallel transmission circuit.

11. A semiconductor integrated circuit according to claim 10, comprising a PLL circuit that multiplies the system clock n-fold,
wherein an n-fold clock outputted from the PLL circuit is supplied as an operating clock of the second sense amplifier, a serial transmission circuit, and a serial/parallel conversion circuit.

12. A semiconductor integrated circuit according to claim 1, further comprising:
a CPU;
a memory in which data including a bit representing whether the data is an instruction or not is present;
an instruction notification circuit that provides notification as to whether data that is read next is an instruction or not from a current operation of the CPU;
an instruction determination circuit that determines whether or not the bit representing whether the data is an instruction or not which bit is included in the data outputted from the memory and the instruction notification signal outputted from the instruction notification circuit coincide with each other, by comparing the bit and the instruction notification signal with each other; and
stop signal generation means for generating a CPU stop signal when the instruction determination circuit determines that the bit and the instruction notification signal do not coincide with each other.

13. A semiconductor integrated circuit according to claim 8, further comprising:
a CPU;
a memory in which data including a bit representing whether the data is an instruction or not is present;
an instruction notification circuit that provides notification as to whether data that is read next is an instruction or not from a current operation of the CPU;
an instruction determination circuit that determines whether or not the bit representing whether the data is an instruction or not which bit is included in the data outputted from the memory and the instruction notification signal outputted from the instruction notification circuit coincide with each other, by comparing the bit and the instruction notification signal with each other; and
stop signal generation means for generating a CPU stop signal when the instruction determination circuit determines that the bit and the instruction notification signal do not coincide with each other.

14. A semiconductor integrated circuit according to claim 1, comprising a CPU, a memory, and an address correction circuit,
wherein when noise is sensed by the noise detection circuit, the CPU is temporarily stopped, and data of an address corrected by the address correction circuit is obtained from the memory, and the operation of the CPU is restored.

15. A semiconductor integrated circuit according to claim 8, comprising a CPU, a memory, and an address correction circuit,
wherein when noise is sensed by the noise detection circuit, the CPU is temporarily stopped, and data of an address corrected by the address correction circuit is obtained from the memory, and the operation of the CPU is restored.
